(19) United States
(12) Patent Application Publication
(10) Pub. No.: US 2006/0277741 A1
(43) Pub. Date: Dec. 14, 2006

(54) Wall panel jig system and method

(76) Inventor: Doug Anderson, Baldwin, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/326,761

(22) Filed: Jan. 6, 2006

Related U.S. Application Data
(60) Provisional application No. 60/643,194, filed on Jan. 11, 2005.

(51) Int. Cl. B21D 39/03; B23P 21/00

(52) U.S. Cl. 29/429; 29/771; 29/772

(57) ABSTRACT

A wall panel jig system and method. The system typically includes two side supports having a jig-frame rotatably connected between the supports. The frame can rotate freely between the two supports but can be locked into place. The outer steel frame tracks, which form the perimeter of the steel frame, are connected within the jig-frame and the steel studs are then connected to the tracks. The jig-frame rotates to allow the builder to make connections all around the steel frame. When all the studs are connected, a roll table is brought near the jig and the steel frame is guided onto the table to allow a plywood wall to be built onto the frame thus completing the prefabricated wall. The walls can then be transported to their final destination for installation.

Priority based on U.S. Provisional Patent Application, Ser. No. 60/643,194, filed Jan. 11, 2005, and entitled “Wall Panel Jig System and Method”, is claimed.

### BACKGROUND

I. Field of the Invention

The present invention relates generally to the field of construction and more particularly to a wall panel jig system and method.

II. Description of the Related Art

Constructing steel walls is typically attained by connecting outer steel tracks and respective steel studs on a level surface. Often times, construction can be unruly and maintaining level construction can be difficult, because the steel stud walls are difficult to maintain upright for level manufacture. Typically, the walls must be constructed on a level surface or on a stationary jig, wherein the user manufacturing the wall must walk around and attach the studs to the outer tracks while attempting to maintain a level and square fit.

### SUMMARY

In general, the invention features a wall panel jig system and method for constructing prefabricated walls. The system is used to aid in the construction of steel frame homes and other structures. The jig allows individual walls to be built and thus prefabricated for installation into the structure. The result is that walls are built faster and straighter than if built from the ground. The jig generally includes two side supports having a jig-frame rotatably connected between the supports. The frame can rotate freely between the two supports but can be locked into place. The outer steel frame tracks, which form the perimeter of the steel frame, are connected within the jig-frame and the steel studs are then connected to the tracks. The jig-frame rotates to allow the builder to make connections all around the steel frame. When all the studs are connected, a roll table, typically on tracks, is brought near the jig, and subsequently connected to the jig. The steel frame is then guided onto the table to allow a plywood wall, or other suitable material, to be built onto the frame thus completing the prefabricated wall. The walls can then be transported to their final destination for installation.

In general, in one aspect, the invention features a wall panel jig system, including upright side supports generally parallel to one another, a frame rotatably connected between the side supports, tracks located around the perimeter of the frame and lock bars connected between the side supports and the frame.

In one implementation, the frame includes an upper elongated rail, a lower elongated rail generally parallel to the upper elongated beam and two side rails, generally parallel to one another and perpendicular to the upper and lower elongated beams.

In another implementation, the system further includes a rail leveling bar connected to each of the upper and lower beams.

In another implementation, each rail leveling bar includes an elongated pipe having bends such that a portion of either end of the pipe is connected to the beam and a portion of either end of the pipe bends toward an apex located a distance from the beam, the pipe portions and portion of the beam generally forming a triangle.

In another implementation, the system further includes a length of pipe connected between the apex and the beam.

In another implementation, the system further includes a nut in threaded engagement with a threaded portion of the length of pipe, the nut being in contact with a portion of the beam.

In another implementation, the tracks are a series of track guides located on a side of the upper and lower beams.

In another implementation, the system further includes a steel frame wall panel held within the frame.

In another implementation, the system further includes a roll table located adjacent the frame and side supports for guiding the steel wall panel from the frame and onto the roll table.

In another aspect, the invention features a method for prefabricating steel frame wall panels, including positioning outer steel frame tracks around an inner perimeter of a wall jig frame, connecting the steel frame tracks to one another, positioning steel studs in between upper and lower steel frame tracks and connecting the studs to one of the upper and lower tracks, rotating the jig frame about a pivot point on two upright side supports, fixing the frame with respect to the upright side supports and connecting the studs to the remaining of the upper and lower tracks.

In one implementation, the method further includes bringing a roll table near the jig and guiding the steel frame onto the table.

In another implementation, the method further includes affixing plywood to the frame.

In another implementation, the method further includes removing the frame connected to the plywood from the roll table.

In another aspect, the invention features a prefabricated steel frame wall formed by the process, including fixing steel tracks within a frame pivotally connected between two upright side supports, fixing steel studs to the steel tracks within the frame and rotating the frame to connect the tracks and the studs to one another.

In another aspect, the invention features a wall panel jig system, including a jig frame pivotally connected between upright side supports, means for fixing the position of the jig frame with respect to the upright side supports, means for leveling the jig frame between the upright side supports and means for coupling the jig frame to a roll table.

One advantage of the invention is that steel frame walls can be quickly fabricated in a freely rotatably frame.

Another advantage of the invention is that steel walls can be prefabricated while maintaining a level construction.

Another advantage of the invention is that pre-fabricated walls can be produced much quicker than if built on the ground or other level surface.

Another advantage of the invention is that the pre-fabricated walls are more structurally stable and straighter than walls built on the ground or other level surface.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates a front view of an embodiment of a wall panel jig apparatus;

FIG. 2 illustrates a front view of an alternate embodiment of a wall panel jig apparatus;

FIG. 3 illustrates a perspective view of an embodiment of a lock bar for an embodiment of a wall panel jig apparatus;

FIG. 4 illustrates a front view of an embodiment of beam leveling bars for an embodiment of a wall panel jig apparatus;

FIG. 5 illustrates a perspective view of an embodiment of a wall panel jig system having an embodiment of a wall panel jig apparatus and an embodiment of a roll table;

FIG. 6A illustrates a view of an embodiment of a wall panel jig apparatus in a first rotated position;

FIG. 6B illustrates a view of an embodiment of a wall panel jig apparatus in a second rotated position;

FIG. 6C illustrates a view of an embodiment of a wall panel jig apparatus in a third rotated position; and

FIG. 7 illustrates an embodiment of a prefabricated wall panel on an embodiment of a roll table.

### DETAILED DESCRIPTION

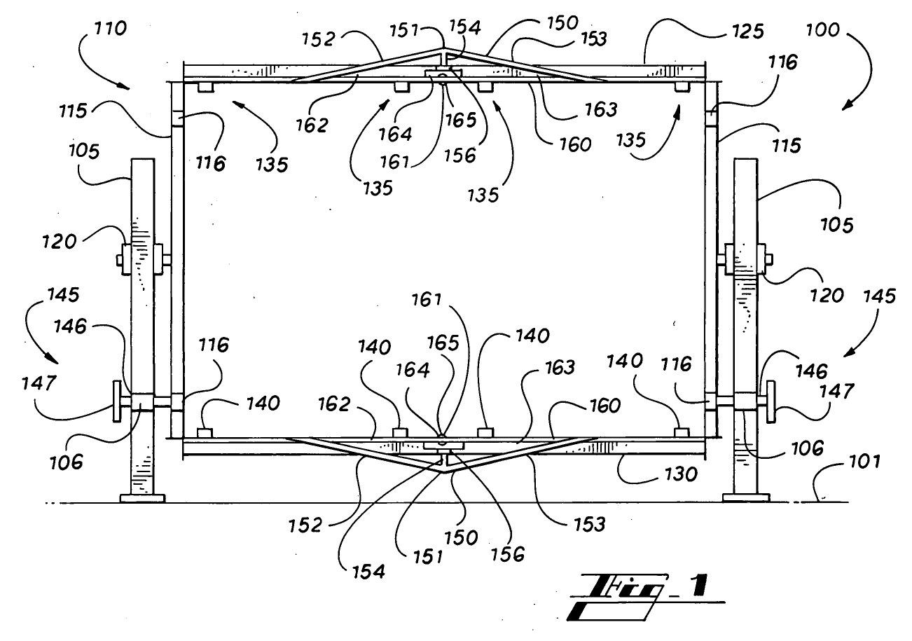

Referring to the drawings wherein like reference numerals designate corresponding parts throughout the several figures, reference is made first to FIG. 1 that illustrates a front view of an embodiment of a wall panel jig apparatus 100. In general, the wall panel jig apparatus 100 typically includes upright side supports 105 generally parallel to one another and typically mounted to a ground surface 101. The apparatus 100 typically further includes a frame 110 rotatably connected between the side supports 105. The frame 110 typically includes side rails 115 that are rotatably connected to the upright side supports 105 via rotating bearings 120. The frame 110 further includes upper and lower elongated rails 125, 130 that are connected generally perpendicular to the side rails 115 thereby forming the generally rectangular frame 110. Therefore, the side rails 115 and the upper and lower elongated rails 125, 130 generally form the perimeter of the frame 110. Track guides 135, 140 are formed generally in the upper and lower elongated rails 125, 130 and are generally flush with one side of the elongated rails 125, 130. Therefore, the elongated rails 125, 130 generally form an outer perimeter guide for a prefabricated wall, through the presence of the track guides 135, 140 that allow wall components such as the upper and lower tracks (further discussed in the description below). The frame 110 typically outlines standard wall panel types, typically used in prefabricated steel structures. As such, the frame 110 is typically a rectangular shape and can be adjusted as necessary when prefabricating wall panels of varying sizes.

The apparatus 100 further includes lock bars 145 connected between the upright side supports 105 and the side rails 115 of the frame 110, as illustrated in FIG. 3 that illustrates a perspective view of an embodiment of a lock bar 145 for an embodiment of the wall panel jig apparatus 100. The lock bars 145 are typically T-shaped, although other orientations are contemplated. An elongated bar 146 is positioned through a first sleeve 106 connected on each of the upright supports 105 and then through a second sleeve 116 positioned on the side rails 115 of the frame 110. As such, when positioned through the sleeves 106, 116, the elongated bar 146 prevents relative movement between the upright side supports 105 and the side rails 115. A second short bar 147 generally forms a handle that is connected perpendicular to the elongated bar 146 thereby forming the T-shape. The lock bars 145 therefore maintain the frame 110 in a stationary position relative to the upright side supports 105. When the lock bar 145 is removed from the sleeves 106, 116, the frame 110 is free to rotate about the bearings 120, the advantages of which are discussed further in the description below. Since the frame 110 is adapted to rotate within the upright side supports 105 and then be locked into a fixed position so that the wall tracks and studs can be connected into place, the side rails 115 include sleeves 116 on upper and lower portions of the side rails so that the lock bars 145 can remain filed in one place, but have a corresponding sleeve 116 positioned in the correct location when the frame 110 is rotated into both desirable locked positions.

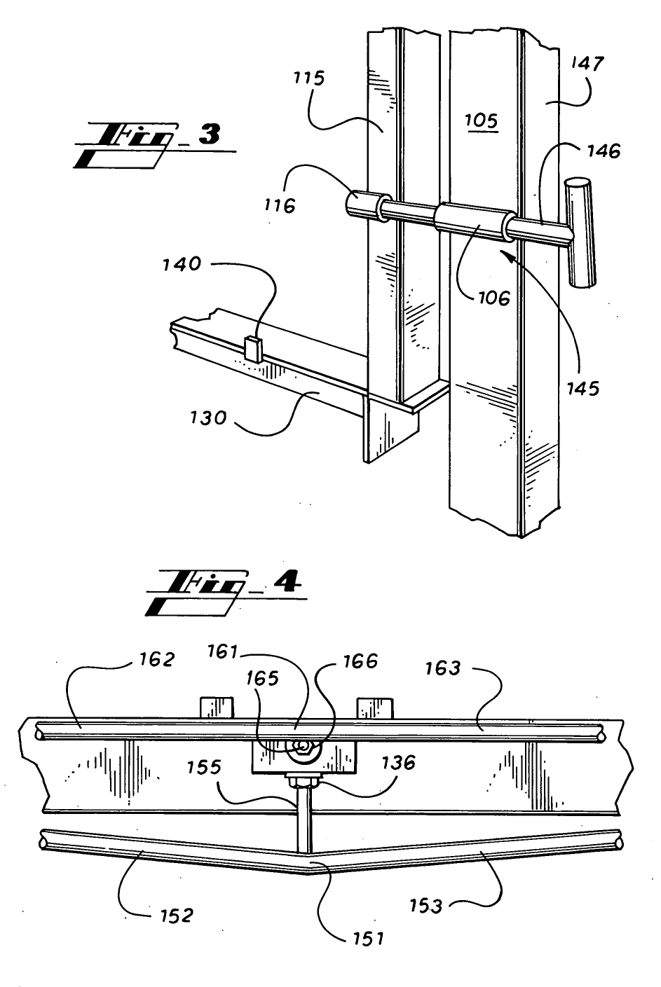

Since the beams 115, 125, 130, particularly the upper and lower elongated rails 125, 130, are elongated, the force of gravity can pull on the rails 115, 125, 130 thus causing a degree of sag in the rails 115, 125, 130, which can in turn cause sag in the tracks and studs placed in the frame 110 for the prefabricated wall. As such, a rail leveling bars 150, 160 are connected to each of the upper and lower elongated rails 125, 130. FIG. 4 illustrates a front view of an embodiment of rail leveling bars 150, 160 for an embodiment of a wall panel jig apparatus 100. Each of the rail leveling bars 150, 160 typically include an elongated pipe having bends such that a portion of either end of the pipe is connected to the respective rail 125, 130 and a portion of either end of the pipe bends toward an apex 151, 161, located a distance from the respective rail 125, 130, the pipe portions 152, 153, 152, 153 and portion of the respective rail 125, 130 generally forming a triangle. A short length of pipe 155, 165 is connected between the apex 151,161 and the beam 125, 130. Typically, a nut 156, 166 is in threaded engagement with a threaded portion of the short length of pipe 155, 165, the nut 156, 166 being in contact with a portion of the rail 125, 130. Therefore, the nut 156, 166 can be rotated to adjust the sag in the beams 125, 130 as needed. The nut 156, 166 therefore causes the short length of pipe 155, 165 to push against the apex 151, 161 which in turn resists the push. Therefore, an opposite reaction to this resistance results in the sag of the rails 125, 130 to be straightened.

In a typical embodiment, the frame 110 is locked in between the upright side supports 105 by the lock bars 145 during panel prefabrication, as mentioned above. In this orientation, one rail leveling bar 150 can be connected to the beams generally perpendicular to the ground. The additional rail leveling bar 160 can be connected to each rail adjacent the first rail leveling bar 150 but generally parallel to the ground to adjust leveling sideways in the rails. In this way, the orthogonal leveling arrangement of the rail leveling bars 150, 160 allows the rails 125, 130 to be adjusted to create the best square orientation for the placement of the prefabricated wall components.

In a typical embodiment, the track guides 135, 140 located in the frame 110 are a series of lips located on a side of the upper and lower rails 125, 130. In this way, the steel tracks can be placed into the frame 1 10 and set against the track guides 135, 140 in a preset orientation that properly position the outer tracks of the panel with respect to each other. Once the outer tracks are connected to each other as described further below, the studs can be easily be placed in the outer tracks and connected. The outer steel tracks and respective studs, once complete, form the prefabricated steel frame panel, discussed further in the description below. During prefabrication, the outer steel tracks can be held within the frame with C-clamps, which are connected between the steel tracks and the rails 115, 125, 130 of the frame 110.

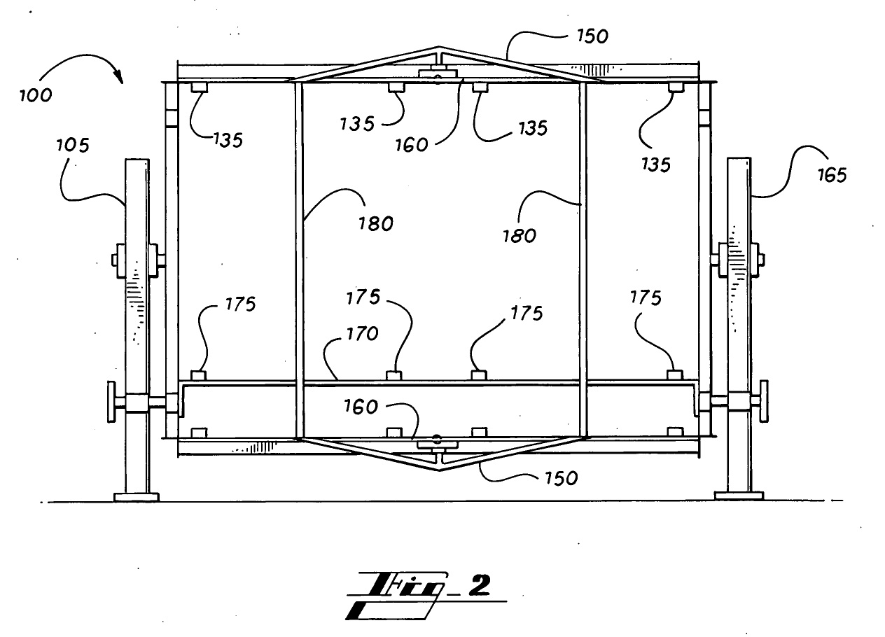

Since several different sized prefabricated panels can be created using the embodiment of the wall panel jig apparatus as described above, the apparatuses can be formed in different dimensions. Alternatively, the apparatus 100 as described above can be resized by advantageously adding different cross rails. FIG. 2 illustrates a front view of an alternate embodiment of a wall panel jig apparatus 100. The general components of the apparatus are the same as described with respect to FIG. 1. However, an alternate lower elongated rail 170 having track guides 175 with similar function to the track guides 135, 140 as described above. The lower elongated rail 170 is connected between the side rails 115 and generally parallel to the upper and lower elongated rails 125, 130. Vertical support rails 180 are connected between the upper and lower elongated rails 125, 130 and connected to and perpendicular with the upper and lower elongated rails 125, 130 and the alternate lower elongated rail 170.

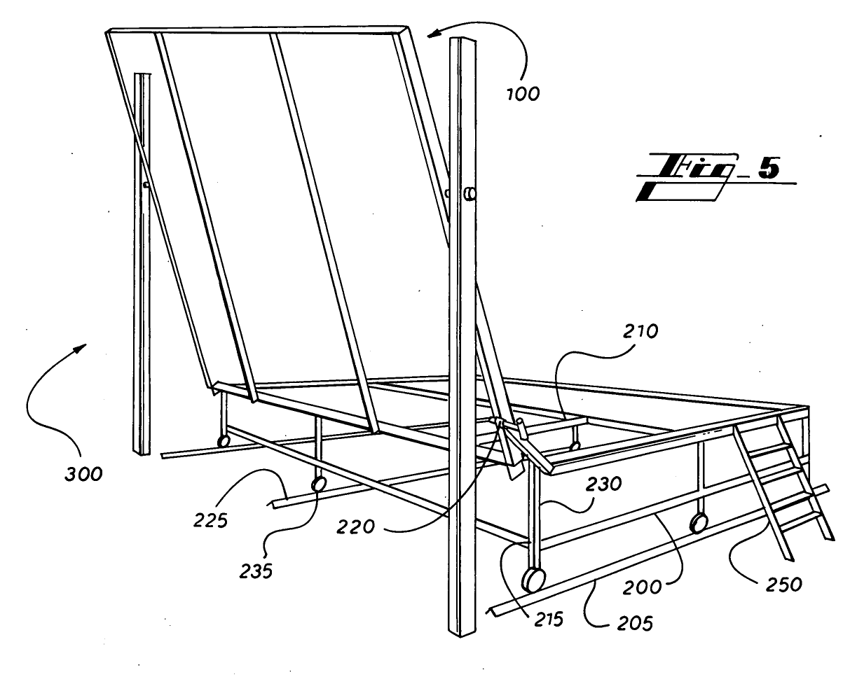

The apparatus 100 can be used in conjunction with an embodiment of a detached roll table to form a wall panel jig system as shown in FIG. 5 that illustrates a perspective view of an embodiment of a wall panel jig system 300 having an embodiment of a wall panel jig apparatus 100 and an embodiment of a roll table 200. The roll table 200 typically includes a framed body 205 having a series of smaller rectangular frames 210 formed generally in an upper defined plane of the framed body 205. The roll table further includes arms 215 connected to the framed body 205. One end of the arms 215 are pivotally connected to the framed body 205. The other end of the arms 215 includes a sleeve 220. When the prefabricated wall is complete, the lock bars 145 of the apparatus 100 can be removed from the respective sleeves 106, 116 on the apparatus 100. The frame 110 can then be partially rotated to align the sleeves 116 on the side rails to be aligned with the sleeves 220 on the arms 215. When aligned, the lock bars 145 can be reconnected to thereby couple the partially rotated frame 110 to the framed body 205. In this way, as further discussed in the description below, the prefabricated wall can be removed from the frame 110 and be complete atop the roll table 200, which typically includes the affixation of plywood or other suitable panel onto the steel frame panel. A prefabricated steel frame wall panel 400 is illustrated as being moved from the frame 110 to the roll table 200.

The roll table 200 is typically located on fixed tracks 125 adjacent the apparatus 100 for ease of placement and preset alignment. The framed body 205 therefore, includes legs 230 having wheels 235 coupled to the tracks 225. In this way, the roll table 200 can be easily moved toward and away from the apparatus 100 as needed. A ladder 250 is typically connected to the framed body 205 to allow users to climb on top of the roll table once the panel 400 is placed atop the roll table 200 for additional fabrication.

In general, the method for prefabricating wall panels includes positioning outer steel frame tracks around an inner perimeter of the wall jig frame 110. In this first orientation, the frame 110 is typically perpendicular to the ground 101 and held locked relative to the upright side supports 105 via the lock bars 145 as described above. The lock bars 145 are used to maintain the upright orientation of the frame such that the steel tracks can be manipulated and oriented as need within the frame prior to interconnection. Most typically, a lower steel track is placed against the track guides 140 on the lower rail 130. The track guides 140 help to place the track in the desired orientation. C-clamps can then use be placed to maintain the track in position, The lock bars 145 are then removed and the frame is rotated into the second desired position, which is again perpendicular to the ground 101 with the frame maintained in place with the lock bars. The upper track can then be placed against the track guides 135 on the upper rail 125, which is now closest to the ground 101. Another C-clamp can be placed to keep the track in place, positioned against the track guides in a desired orientation. The side tracks can then be placed and connected, with the studs and whatever additional tracks and shorter studs needed to frame windows and doors.

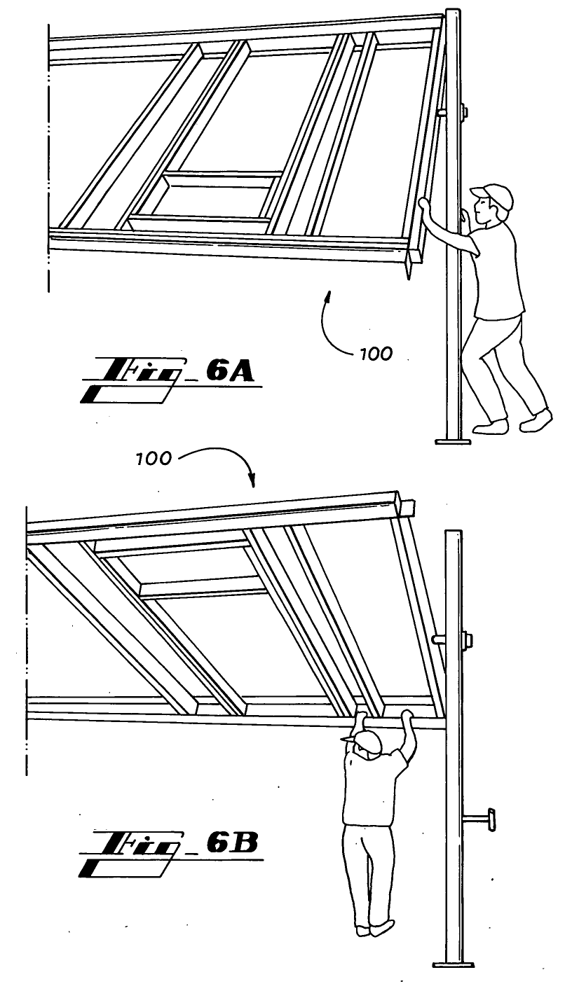

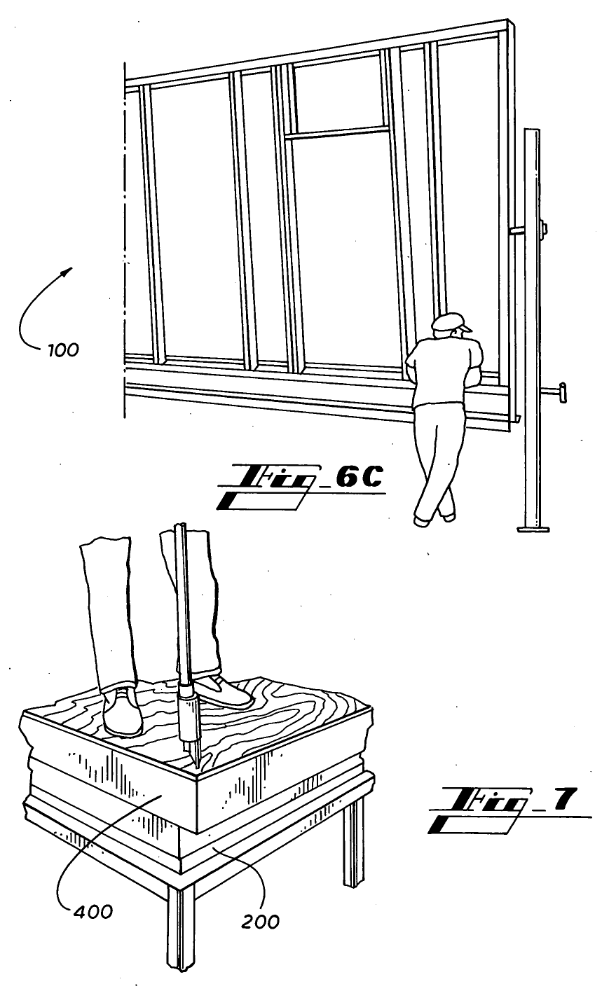

The method typically further includes connecting the steel frame tracks to one another typically using self tapping screws, positioning steel studs in between upper and lower steel frame tracks and connecting the studs to one of the upper and lower tracks, once again typically using self-tapping screws. The frame 110 can be further rotated about the pivot point bearing 120 on upright two side supports 105, fixing the frame 110 with respect to the upright side supports 105, typically by interconnecting the lock bars 145 in between the upright side supports 105 and the frame 110 as described above. Once rotated, additional self-tapping screws, or other suitable connection device can be added to the tracks and studs as needed. In general, FIGS. 6A-6C illustrate several positions in which the frame 110 can be rotated between the upright side supports 105 during fabrication of the steel frame wall. FIG. 6A illustrates a view of an embodiment of a wall panel jig apparatus 100 in a first rotated position. FIG. 6B illustrates a view of an embodiment of a wall panel jig apparatus 100 in a second rotated position. FIG. 6C illustrates a view of an embodiment of a wall panel jig apparatus 100 in a third rotated position.

Referring again to FIG. 5, once the prefabricated steel frame is complete, the method typically further includes bringing the roll table 200 near the jig apparatus 100 and guiding the prefabricated steel frame onto the table. In general, the steel frame wall panel is affixed with respect to the frame 110 and is freely rotatable within the upright side supports 105 when the lock bars 145 are removed. The frame 110 can then be positioned near the roll table 200. The frame 110 can be fixed to the roll table by replacing the lock bars 145 between the frame 110 and the roll table 200 as described above, thus holding the frame 110 locked relative and adjacent the roll table 200. In this way, the C-clamps can be removed and the steel panel can be guided onto the roll table 200.

FIG. 7 illustrates an embodiment of a prefabricated wall panel 400 on an embodiment of a roll table 200. Once the steel panel 400 is laying on the roll table 200, plywood, or other suitable material to create walls on the panel 400, can then be affixed, typically nailed to the panel, thus completing the prefabricated wall that can then be transported for installation into a final structure.

In general, the embodiments of the systems and methods described above have been discussed with use of steel panels. It is understood that other types of panels such as wood can also be constructed using the systems and methods described herein.

The foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A wall panel jig system, comprising:
upright side supports generally parallel to one another;
a frame rotatably connected between the side supports;
tracks located around the perimeter of the frame; and
lock bars connected between the side supports and the frame.

2. The system as claimed in claim 1 wherein the frame comprises:
an upper elongated rail;
a lower elongated rail generally parallel to the upper elongated beam; and
two side rails, generally parallel to one another and perpendicular to the upper and lower elongated beams.

3. The system as claimed in claim 2 further comprising a rail leveling bar connected to each of the upper and lower beams

4. The system as claimed in claim 3 wherein each rail leveling bar comprises:
an elongated pipe having bends such that a portion of either end of the pipe is connected to the beam and a portion of either end of the pipe bends toward an apex located a distance from the beam, the pipe portions and portion of the beam generally forming a triangle.

5. The system as claimed in claim 4 further comprising a length of pipe connected between the apex and the beam.

6. The system as claimed in claim 5 further comprising a nut in threaded engagement with a threaded portion of the length of pipe, the nut being in contact with a portion of the beam.

7. The system as claimed in claim 1 wherein the tracks are a series of track guides located on a side of the upper and lower beams.

8. The system as claimed in claim 1 further comprising a steel frame wall panel held within the frame.

9. The system as claimed in claim 8 further comprising a roll table located adjacent the frame and side supports for guiding the steel wall panel from the frame and onto the roll table.

10. A method for prefabricating steel frame wall panels, comprising:
positioning outer steel frame tracks around an inner perimeter of a wall jig frame;
connecting the steel frame tracks to one another;
positioning steel studs in between upper and lower steel frame tracks and connecting the studs to one of the upper and lower tracks;
rotating the jig frame about a pivot point on two upright side supports;
fixing the frame with respect to the upright side supports; and
connecting the studs to the remaining of the upper and lower tracks.

11. The method as claimed in claim 10 further comprising bringing a roll table near the jig and guiding the steel frame onto the table.

12. The method as claimed in claim 11 further comprising affixing plywood to the frame.

13. The method as claimed in claim 12 further comprising removing the frame connected to the plywood from the roll table.

14. A prefabricated steel frame wall formed by the process, comprising:
fixing steel tracks within a frame pivotally connected between two upright side supports;
fixing steel studs to the steel tracks within the frame; and
rotating the frame to connect the tracks and the studs to one another.

15. A wall panel jig system, comprising:
a jig frame pivotally connected between upright side supports;
means for fixing the position of the jig frame with respect to the upright side supports;
means for leveling the jig frame between the upright side supports; and
means for coupling the jig frame to a roll table.
